(19) United States
(12) Patent Application Publication
(10) Pub. No.: US 2007/0134411 A1
(43) Pub. Date: Jun. 14, 2007

(54) Method for making compositions containing microcapsules and compositions made thereof

(75) Inventors: Nicola Cont, Bergen of Zoom (NL); Frans Mercx, Bergen op Zoom (NL); Robert Borst, Zevenbergen (NL)

Correspondence Address: GEAM - LNP-CE 08CE;IP LEGAL, ONE PLASTICS AVENUE, PITTSFIELD, MA, 01201-3697, US

(73) Assignee: General Electric Company

(21) Appl. No.: 11/326,213

(22) Filed: Jan. 5, 2006

Related U.S. Application Data
(60) Provisional application No. 60/750,153, filed on Dec. 14, 2005.

(51) Int. Cl. B01J 13/02

(52) U.S. Cl. 427/213.34

(57) ABSTRACT

In the process of the invention, a composition is made by mixing a plurality of microcapsules containing at least an additive such as lubricants, oils, fragrances, colorants, etc., with a dispersing polymeric material to form a first blend, and compounding the first blend into a base containing at least a polymeric material at a temperature of less than 370° C., whereas the resulting composition is substantially free of segregated microcapsules and heat degraded shell.

### CROSS REFERENCE TO RELATED APPLICATION

This application claims priority to U.S. Patent Application Ser. No. 60/750153 filed Dec. 14, 2005, which patent application is fully incorporated herein by reference.

### FIELD OF INVENTION

The present invention relates to a novel method for making compositions and/or articles containing microcapsules, particularly a method for making a self-lubricating thermoplastic compositions containing lubricant microcapsules with improved wear properties made thereof.

### BACKGROUND OF INVENTION

Microcapsules are widely used in a number of applications. A wide number of materials have been encapsulated, e.g. adhesives, agrochemicals, catalysts, lubricants, living cells, flavorants, fragrances, pharmaceuticals, vitamins, etc., in both liquid and solid form. Resin compositions have been disclosed in the prior art for a number of applications, self-lubricating compositions for wear-resistant applications such sealant elements, conveyor applications, etc.; antimicrobial resin compositions for antimicrobial medical, sanitary, household articles, etc., e.g., rubber stopper for injection bottle, adhesive plaster, mouthpiece, etc.

Microcapsule shells comprise a number of different materials, from organic polymers to waxes and fats. In applications wherein microcapsules are used in polymeric composites, the break down of microcapsules, particularly microcapsules having containing urea-formaldehyde copolymer (PMU) as the shell, causes releasing formaldehyde, which is an occupational and health hazard.

The prior art is either silent about the approach to best incorporate microcapsules containing lubricants into the polymer composites, or offers cautious advice as in Japanese Patent Publication No. H1-129067: “These microcapsules should not breakdown (be destroyed) due to the mixing shear force or the processing heat at the time of adding and dispersing in the base synthetic resin. Consequently, the high molecular material, which becomes the wall material (film), should be selected carefully so that the microcapsule is not destroyed under the processing conditions or processing state of the base synthetic resin.”

In the practice of the prior art, microcapsules are incorporated into high-temperature thermoplastic compositions via one of the followings: extrusion followed by injection molding, dry-blending in combination with injection molding; and dry-blending polymer granules together with microcapsules followed by compression molding. The prior art processes lead to thermal degradation of the microcapsule shells, with the consequence of uncontrolled release of the oil and generation of smoke. Additionally, splay and or burn marks are visible in the articles manufactured.

The invention relates to an improved process to incorporate encapsulated materials in materials to avoid segregation of the microcapsules and/or heat degradation of the encapsulated shells. Furthermore, the composition manufactured by the process of the invention may be used in one embodiment for making articles of complex shapes, with little or no visible splay/burn marks.

### SUMMARY OF THE INVENTION

In one aspect, the invention relates to a process for a composition by mixing a plurality of encapsulated materials containing at least an additive with a dispersing polymeric material to form a first blend, and compounding the first blend into a base containing at least a polymeric material at a process temperature <370° C., whereas the resulting composition is substantially free of segregated capsules and heat degraded shell.

In one embodiment, the plurality of microcapsules are dry-blended with a dispersing polymeric material that is the same as the resin forming polymer base. In another embodiment, the plurality of microcapsules are dry-blended with a dispersing polymeric material having a melting point of <285° C., forming a masterbatch, wherein the dispersing polymer is different from that of the resin forming the polymer base and wherein the first blend is a masterbatch.

In yet another aspect, the invention relates to a polymeric composition formed by first dry-blending a plurality of microcapsules with at least a carrier polymeric resin, and compounding the dry-blend of microcapsules and the carrier polymer with at least a second polymeric resin, the second polymeric resin being the same or different from the carrier polymeric resin, whereas the resulting composition is substantially free of segregated microcapsules and heat degraded shell.

The invention further relates to articles comprising a polymeric composition formed by first dry-blending a plurality of microcapsules with at least a carrier polymeric resin, and compounding the dry-blend of microcapsules and the carrier polymer with at least a second polymeric resin, the second polymeric resin being the same or different from the carrier polymeric resin, whereas the resulting composition is substantially free of segregated microcapsules and heat degraded shell.

Lastly, the invention relates to components for use in sliding applications or applications with rubbing contacts between surfaces such as piston for automotive engines, conveyer belts, seal assembly for turbines, seal assembly for compressors, sealing elements and the like, comprising a self-lubricating polymeric composition formed by blending a plurality of microcapsules with at least a carrier polymeric resin forming a first blend, and subsequent melt-blending of the first blend with a polymeric matrix in a process with a formaldehyde release of less than the maximum allowable concentration of 1 ppm.

### DETAILED DESCRIPTION OF THE INVENTION

The terms “a” and “an” herein do not denote a limitation of quantity, but rather denote the presence of at least one of the referenced item. All ranges disclosed herein are inclusive and combinable. Furthermore, all ranges disclosed herein are inclusive of the endpoints and are independently combinable.

As used herein, approximating language may be applied to modify any quantitative representation that may vary without resulting in a change in the basic function to which it is related. Accordingly, a value modified by a term or terms, such as “about” and “substantially,” may not to be limited to the precise value specified, in some cases. In at least some instances, the approximating language may correspond to the precision of an instrument for measuring the value.

As used herein, the term “microcapsule” or “microcapsules” may be used interchangeably with “capsules,” “encapsulated microparticles,” “microparticles,” “nanocapsules,” referring to capsules of micro or nano sizes having at least an additive selected from fragrances, pharmaceuticals, vitamins, phase change materials such as lubricating agents, etc., incorporated or encapsulated in microcapsules.

As used herein, the term “phase change material” can include any substance (or mixture of substances) that has the capability of absorbing or releasing thermal energy to reduce or eliminate heat flow at or within a temperature stabilizing range. In one embodiment of the invention, the microcapsules contain at least a lubricant.

As used herein, the term “substantially free of segregated microcapsules and heat degraded shell” means that only a small amount of the microcapsules breakdown in the process of making the composition. In one embodiment, less than 10% of the compounded microcapsules break down (get destroyed/degraded) in the process. In one embodiment, less than 5% of the compounded microcapsules get destroyed/degraded in the process. In a third embodiment, less than 5% of the compounded microcapsules get destroyed/degraded. In a fourth embodiment, less than 3%.

The degradation of microcapsules may detected via the use of Pulsed-NMR technique (p-NMR). As the microcapsules are broken, the lubricant is released in the polymer matrix and looses it flexibility, thus loosing its p-NMR signal.

In one embodiment wherein the shell of the microcapsules contains a urea-formaldehyde copolymer (PMU) such as polyoxymethylene urea, the composition made by the process of the invention is substantially free of segregated microcapsules and heat degraded shell such that the amount of formaldehyde released due to the degradation of the shell is less than 0.75 ppm as an eight hour time weighted average (TWA) unit. In a second embodiment, the TWA level is less than 0.30 ppm formaldehyde release, which is the recommended limited by the US National Institute for Occupational Safety and Health (NIOSA). In a third embodiment, the release is less than the maximum allowable concentration (MAC) of 1 ppm.

The composition made by the process of the invention comprises at least one polymeric carrier; a plurality of microcapsules containing at least an additive such as a lubricant; and at least one polymeric resin as the polymer matrix material. The carrier polymer may be the same or different from the polymer comprising the matrix material.

Microcapsules containing additives. In the process of the invention, the microcapsules are uniformly dispersed within the polymer composition in a manner as to achieve final contents by weight of 1-30 wt. %. In a second embodiment, the microcapsules are present in an amount between 2-25 wt. %. In a third embodiment, the microcapsules are present in a final amount of 3-20 wt. %. In a fourth embodiment, the microcapsules are present in an amount of 5-15 wt. %.

Depending on the final end-use applications of the polymeric compositions and/or the microencapsulating techniques, the shell for containing the lubricating oils may comprise a material selected from waxes animal waxes, vegetable waxes or petroleum waxes; gelatin; polyvinyl alcohol; methylcellulose; polyvinylpyrrolidone; polyterephthalamide; and other polymers such as polyoxymethylene urea (PMU). PMU is the commonly used shell for microcapsules.

The microcapsules can have the same or different shapes or sizes. They may be spherical, ellipsoidal, symmetrical or irregularly shaped. In one embodiment, the microcapsules have a maximum linear dimension (e.g., diameter) ranging from about 0.01 to about 2000 μm. In another embodiment, the microcapsules have a generally spherical shape and a maximum linear dimension ranging from about 0.5 to about 500 μm. In a third embodiment, a diameter from 1 to about 200 μm. In a fifth embodiment, a diameter from about 3 to 100 μm

The capsules containing the additives such as lubricating oils may be produced using various microencapsulation technologies known in the art, including dry spraying, prilling, coacervation, with soft alginate beads and in situ polymerization, etc, including methods as disclosed in U.S. Pat. No. 5,112,541, PCT Patent Publication No. WO9822549A1, and also in “Development of Micro and Nano-encapsulation Techniques” by Prof. Kiparissides of Chemical Process Engineering Research Institute, Aristotle University of Thessaloniki (2004). The method employed depends on the required dimensions of the lubricating particles and the end-use applications of the polymer compositions of the invention.

In one embodiment wherein the microcapsules are produced using the dry spraying process, it is possible to encapsulate the additives in capsules of dimensions as small as 5-30 μm. In another embodiment using a prilling process, microcapsules of sizes between 2 and 2000 μm are produced, with a range of 5-500 μm typically observed. In a third embodiment, they are made using the coacervation method, for microcapsules having sizes of 25-300 μm. In yet another embodiment, the lubricants are encapsulated using an in-situ polymerization process using urea-formaldehyde copolymer (PMU) for a strong polymer shell, for capsules having sizes of 25-300 μm. In a fifth embodiment, the microcapsules are encapsulated in alginate soft beads with easily crushable spheres having sizes of up to 4000 μm.

In one embodiment, the microcapsules contain a phase change material such as lubricating agents, e.g., fluids or oils, contained within a thin film or wax or a shell of PMU. Examples of lubricating oils include organic, natural or synthetic oils. Particularly suitable oils are lubricating oils which are low in acidity and resistant to elevated operating temperatures. In one embodiment, the lubricating oil for use in the microcapsules exhibits viscosity values within the range between 20 and 250 cSt, measured at a temperature of approx. 40° C. In addition to the lubricating oils contained within the microcapsules, other additives may be used depending on the intended application. In particular, for use under elevated pressure conditions, microelements such as zinc, boron, and mixtures thereof may be incorporated.

Carrier Polymer For Forming a First Blend. In one embodiment the microcapsules are encapsulated in PMU shells, which have a lower temperature resistance compared to the resins typically used-for self-lubricating applications. This temperature resistance limits the kind of polymer matrix in which the microcapsules can be incorporated, particularly with high-temperature thermoplastics (Tₘ>285° C.) preferably used sliding/sealing applications. Besides the low temperature limitation of some microcapsule shells, most of the lubricants encapsulated in microcapsules also have a temperature limitation before they get degraded.

In one embodiment of the invention, the inventors alleviate the degradation problem by first melt-blending the microcapsules in at least a carrier polymer which has a melting temperature less than 285° C., forming a masterbatch or a concentrate. In one embodiment, the carrier polymer has a melting temperature less than 260° C. The amount of microcapsules melt-blended in a masterbatch (concentrate or pre-blend) ranges from 1 to 50 wt. % in one embodiment, from 10 to 40 wt. % in a second embodiment, and 10 to 30 wt. % in a third embodiment.

In a second embodiment of the invention, the inventors alleviate the degradation problem by first dry-blending the microcapsules in at least a carrier polymer, and subsequently melt-blending the dry-blended mixture into a later portion of the extruder process via a downstream feeding point or a side feeder to minimize the degradation of the microcapsules at high temperatures. The amount of microcapsules dry-blended in the mixture ranges from about 1 to 80 wt. % in one embodiment, from 5 to 70 wt. % in a second embodiment, and from 10 to 50 wt. % in a third embodiment.

In one embodiments wherein the microcapsules are melt-blended into a master batch, the carrier polymer is selected from a thermoplastic polymer (or a mixture of thermoplastic polymers) having a melting temperature less than 285° C. In a second embodiment, the carrier polymer is selected from thermoplastic resins having a melting temperature of less than 260° C.

Examples of carrier polymers having a low melting point include but not limited to polyesters such as polyethylene terephthalate, polybutylene terephthalate; polycarbonate including polycarbonate homopolymers, polyestercarbonate copolymers, linear aromatic polycarbonate resins, branched aromatic polycarbonate resins and poly(ester-carbonate) resins; polyamides such as nylon 6, nylon 66, nylon 12, polyacetal, polyolefins such as polyethylene or polypropylene, copolymers (including terpolymers, etc.) of olefins, halogenated vinyl or vinylidene polymers such as polyvinyl chloride, polyvinylidene chloride, polyvinyl fluoride, polyvinylidene fluoride and copolymers of these monomers with each other or with other unsaturated monomers, polyamide copolymers, styrene polymers and copolymers, polyacrylonitrile, thermoplastic silicone resins, thermoplastic polyethers, polyketones, polyimides, thermoplastic modified celluloses, polysulphones and mixtures thereof.

In embodiments wherein the microcapsules are dry-blended into a carrier polymer forming a dry blend mixture, the carrier polymer may be the same or different from the polymer comprising the base polymer matrix, i.e., a high-temperature thermoplastic resin or a polymeric resin with a melting point <285° C. as listed above.

Examples of high-temperature polymers for use as the carrier polymer of the microcapsules include semi-crystalline as well as amorphous polymers. Examples of high-temperature semi-crystalline polymers include polyarylene sulfide such as polyphenylene sulfide (PPS), polyetheretherketone (PEEK), polyetherketone (PEK), polyphthalamide (PPA), polyetherketoneketone (PEKK), thermoplastic polyimide (TPI), high temperature nylon (HTN), and blends thereof. Examples of high-temperature amorphous polymers include polysulfone (PSU), polyethersulfone (PES), polyetherimide (PEI), and blends thereof.

In one embodiment polyethylene terephthalate is used as a carrier for the microcapsules for a composition with polyetherimide as the base polymer. In a second embodiment, polyethylene terephthalate is used as a carrier for a composition comprising polyetherether ketone. In a third embodiment, polycarbonate is used as a carrier for a self-lubricating polyetherether ketone composite. In a fourth embodiment, polyamide is used as a carrier for a polyetherether ketone composition.

The amount of carrier polymer ranges from 5 to about 40 weight %, based upon the total weight of the final composition. In a second embodiment, the amount of carrier polymer ranges from 5 to 30 wt. % based on the total weight of the composition. In a third embodiment, the amount of carrier polymer ranges from 5 to 20 wt. % based on the total weight of the composition.

Matrix Polymeric Material as the Polymer Base for Compostion: In general, the matrix polymeric material can include any polymer (or mixture of polymers) that has or provides one or more desired physical properties for a polymeric composite or an article made therefrom. Examples of physical properties include mechanical properties (e.g., ductility, tensile strength, and hardness), thermal properties (e.g., thermoformability), and chemical properties (e.g., reactivity).

According to some embodiments of the invention, the matrix polymeric material can be compatible or miscible with or have an affinity for the carrier polymer. In some embodiments of the invention, such affinity can depend on, for example, similarity of solubility parameters, polarities, hydrophobic characteristics, or hydrophilic characteristics of the carrier polymeric material and the matrix polymeric material.

As with the carrier material, the matrix polymer can be a high-temperature thermoplastic resin as described above, or a polymeric resin with a melting point <285° C. as listed above. Examples of the matrix polymer include but are not limited to polyamides (e.g., Nylon 6, Nylon 6/6, Nylon 12, polyaspartic acid, polyglutamic acid, and so forth), polyamines, polyimides, polyacrylics (e.g., polyacrylamide, polyacrylonitrile, esters of methacrylic acid and acrylic acid, and so forth), polycarbonates (e.g., polybisphenol A carbonate, polypropylene carbonate, etc.), polydienes (e.g., polybutadiene, polyisoprene, polynorbornene, etc.), polyepoxides, polyesters (e.g., polyethylene terephthalate, polybutylene terephthalate, polytrimethylene terephthalate, polycaprolactone, polyglycolide, polylactide, polyhydroxybutyrate, polyhydroxyvalerate, polyethylene adipate, polybutylene adipate, polypropylene succinate, etc.), polyethers (e.g., polyethylene glycol (polyethylene oxide), polybutylene glycol, polypropylene oxide, polyoxymethylene (paraformaldehyde), polytetramethylene ether (polytetrahydrofuran), polyepichlorohydrin, etc.), polyflourocarbons, formaldehyde polymers (e.g., urea-formaldehyde, melamine-formaldehyde, phenol formaldehyde, etc.), natural polymers (e.g., cellulosics, chitosans, lignins, waxes, etc.), polyolefins (e.g., polyethylene, polypropylene, polybutylene, polybutene, polyoctene, etc.), polyphenylenes (e.g., polyphenylene oxide, polyphenylene sulfide, polyphenylene ether sulfone, etc.), silicon containing polymers (e.g., polydimethyl siloxane, polycarbomethyl silane, etc.), polyurethanes, polyvinyls (e.g., polyvinyl butryal, polyvinyl alcohol, polyvinyl acetate, polystyrene, polymethylstyrene, polyvinyl chloride, polyvinyl pryrrolidone, polymethyl vinyl ether, polyethyl vinyl ether, polyvinyl methyl ketone, etc.), polyacetals, polyarylates, copolymers (e.g., polyethylene-co-vinyl acetate, polyethylene-co-acrylic acid, polybutylene terphthalate-co-polytetramethylene terephthalate, polylauryllactam-block-polytetrahydrofuran, etc.), and mixtures thereof.

In one embodiment of the invention, the matrix polymer is selected from at least one of polyphenylene sulfide (PPS), polyetheretherketone (PEEK), polyetherketone (PEK), polyphthalamide (PPA), polyetherketoneketone (PEKK), thermoplastic polyimide (TPI), high temperature nylon (HTN), polysulfone (PSU), polyethersulfone (PES), polyetherimide (PEI), and blends thereof.

The amount of matrix polymer ranges from 15 to about 90 weight %, based upon the total weight of the final composition. In a second embodiment, the amount of matrix polymer ranges from 30 to 80 wt. % based on the total weight of the self-lubricating composition. In a third embodiment, the amount of matrix polymer ranges from 30 to 50 wt. %

Optional Additive Components: Other customary additives may be added to all of the resin compositions at the time of mixing or molding of the resin in amounts as necessary which do not have any deleterious effect on physical properties. For example, coloring agents (pigments or dyes), heat-resistant agents, oxidation inhibitors, organic fibrous fillers, weather-proofing agents, antioxidants, lubricants, mold release agents, flow promoters, plasticizer, and fluidity enhancing agents, and the like, commonly used in thermoplastic compositions may also be added in the amounts desired.

In one embodiment for wear-resistant compositions, in addition to the microcapsules, the composition may further include lubricants in the form of a liquid lubricant, such as a petroleum oil, or a solid dry lubricant such as PTFE.

The composition may further comprise a filler component, including fibrous filler and/or low aspect ratio filler. Suitable fibrous filler may be any conventional filler used in polymeric resins and having an aspect ratio greater than 1, e.g., whiskers, needles, rods, tubes, strands, elongated platelets, lamellar platelets, ellipsoids, micro fibers, nanofibers and nanotubes, elongated fullerenes, and the like. Where such fillers exist in aggregate form, an aggregate having an aspect ratio greater than 1 will also suffice for the fibrous filler. Other examples of fillers including glass fibers, such as E, A, C, ECR, R, S, D, and NE glasses and quartz, and the like. Other suitable inorganic fibrous fillers include those derived from blends comprising at least one of aluminum silicates, aluminum oxides, magnesium oxides, and calcium sulfate hemihydrate. Also included among fibrous fillers are single crystal fibers or “whiskers” including silicon carbide, alumina, boron carbide, iron, nickel, or copper. Other suitable inorganic fibrous fillers include carbon fibers, stainless steel fibers, metal coated fibers, and the like.

Other optional additives may include low aspect fillers include silica powder; boron-nitride powder and boron-silicate powders; alkaline earth metal salts; alumina and magnesium oxide (or magnesia); wollastonite; calcium sulfate; calcium carbonates; talc; glass powders; glass-ceramic powders; clay; mica; feldspar and nepheline syenite; quartz; quartzite; perlite; diatomaceous earth; silicon carbide; zinc sulfide; barium titanate; barium ferrite; barium sulfate and heavy spar; particulate aluminum, bronze, zinc, copper and nickel; carbon black; flaked fillers; and the like. Examples of such fillers well known to the art include those described in “Plastic Additives Handbook, 4^{th} Edition” R. Gachter and H. Muller (eds.), P. P. Klemchuck (assoc. ed.) Hansen Publishers, New York 1993.

The total amount of optional additives present in the composition may be about 0.1 to about 50 wt. % of the total weight of the composition. In one embodiment, in an amount of 3 to about 30 wt. %. In another embodiment, from 5 to about 20 wt. %.

It should be clear that the invention encompasses reaction products of the above-described compositions.

The Method of the Invention: As used herein, “process temperature” is the temperature as initially set for the compounding equipment, e.g., the extruder. In the first embodiment of the method of the invention, at least a carrier polymer having a Tₘ<285° C. is first melt-blended with the microcapsules containing additives forming a first blend of a concentrate or a masterbatch. In a second step, the masterbatch pellets produced can be dry-blended with at least a matrix polymer for subsequent injection molding or compression molding forming articles, or further compounded (melt-blended) with at least a matrix polymer at a process temperature of less than 370° C., yielding granules or pellets or sheets or shaped briquettes of the polymeric compositions. In one example, separate feeders are used to feed the microcapsules and the carrier polymer into an extruder, preferably a twin-extruder. In a second example, the microcapsules are fed downstream from the carrier polymer to minimize the segregation/degradation of the microcapsules. In one example, the processing temperature in the compounding step is less than 350° C. In a second example, at a temperature of less than 300° C. In a third example, the processing temperature is <285° C.

In the second embodiment of the method of the invention, the carrier polymer is first dry-blended with the microcapsules containing additives, e.g., fragrances, lubricants, forming a first dry-blend. In a second step, the dry blend is compounded with at least a matrix polymer, yielding granules or pellets or sheets or shaped briquettes of self-lubricating polymeric compositions.

In the compounding step, the microcapsules are fed using a separate feeder from the matrix polymer, via a side feeder or a feeder downstream from the feeder for feeding the matrix polymer, where the processing temperature is less than 370° C. In one example, the process is a one-pass process wherein a high temperature polymer for a polymer matrix is added at the beginning of the extrusion process via an upstream feeding point, and the microcapsule/carrier polymer dry-blend is added at the later portion of the extruder process via a downstream feeding point. In one example, the processing temperature in the melt-blending step is less than 350° C. In a second example, at a temperature of less than 300° C. In a third example, the processing temperature is <285° C.

Melt blending may involve the use of shear force, extensional force, compressive force, ultrasonic energy, electromagnetic energy, thermal energy or combinations, comprising at least one of the foregoing forces or forms of energy and is conducted in a processing equipment such as a single screw, multiple screws, intermeshing co-rotating or counter rotating screws, non-intermeshing co-rotating or counter rotating screws, reciprocating screws, screws with pins, barrels with pins, rolls, rams, helical rotors, or combinations comprising at least one of the foregoing. Fumed silica may be blended together with the microcapsules in the first embodiment, or the dry blend of the second embodiment to facilitate the flowing of the microcapsules.

Dry-mixing/blending may be conducted in a processing equipment known in the art, e.g., ribbon blenders or high intensity Henschel or Welex mixers

The polymeric composition made by the process of the invention can be further processed forming articles using standard processing techniques known in the art after being extruded into granules or pellets, or cut into sheets or shaped into briquettes for further downstream processing. The composition can then be molded in equipment generally employed for processing thermoplastic compositions, e.g., an injection-molding machine.

The process of the invention is characterized as being advantageously environmental and health compliant with a relatively low release level of undesirable materials due to the minimal degradation of the microcapsules. In one embodiment where microcapsules with urea-formaldehyde copolymer (PMU) shells are used, formaldehyde can be released when the shells get degraded. Formaldehyde is a human carcinogen with a maximum allowable concentration (MAC). In one embodiment, formaldehyde release is measured at the die head using Draeger tubes, between the strands and the fume extraction unit of an extruder equipment. If the formaldehyde level measured is above the MAC level, the operation must be stopped right away and further compounding is not allowed. The MAC level in some countries is 1 ppm.

In one embodiment, the release level is less than 2 PPM for a period of 15 minutes (short term exposure limit (STEL)). In a second embodiment, the release level is less than 0.75 parts per million (PPM) as an eight hour time weighted average (TWA), which is the US Occupational Safety and Health Administration (OSHA) limit. In a third embodiment, the release level is less than 0.016 PPM for an eight hour TWA and with a maximum of 0.1 PPM for a period of 15 minute per recommended limit by the US National Institute for Occupational Safety and Health (NIOSA).

Besides the advantage of favorable operation conditions, in embodiments wherein the microcapsules contain lubricants as the additive, the process of the invention also produces compositions exhibiting excellent wear and friction compared to polymers without the microcapsule addition. In one embodiment, a composition comprising polyester with 10% microcapsule improved the wear factor by 2 orders of magnitude comparable to compositions containing no microcapsule. i.e., with a wear factor K of less than 50, a friction coefficient (μ) of less than 0.04 as measured in a tribological system in which a metal surface bears against a plastic surface. The wear factor K may be measured using methods known in the art, including WI-0687 (which is a modified wear testing method and is similar to ASTM D 3702-78), as disclosed in U.S. patent application Ser. No. 11/175241. Which method is similarly disclosed in U.S. Pat. Nos. 4,749,738; 466,3391; S6,887,938; and U.S. Patent Publication No. 20030004268A1.

In another embodiment, polyetherimide with 10% microcapsule improved the wear factor by 3 orders of magnitude while friction is reduced by at least one order of magnitude comparable to polyetherimide compositions containing no microcapsule. i.e., with a wear factor of less than 50, a friction coefficient (μ) of less than 0.1 as measured in a tribological system in which a metal surface bears against a plastic surface. In another embodiment, polyether etherketone (PEEK) with 30% blend of polyethylene terephthalate/microcapsules made be the process of the invention has an improved the wear factor by 4 orders of magnitude comparable to polyether etherketone compositions containing no microcapsule.

Articles from the Composition The compositions may be made into articles using common processes such as film and sheet extrusion, injection molding, gas-assisted injection molding, extrusion molding, compression molding and blow molding. For compositions containing microcapsules with encapsulated lubricants, the composition may be used to prepare molded articles such as durable articles, structural products, and electrical and electronic components, and the like, particularly in tribological applications in which a surface formed of the composition bears against another surface, including another different plastic surface or a metal surface.

In one embodiment of the invention wherein the microcapsules are fed downstream from the main feeder throat, articles fabricated from the composition of the invention are characterized as being clear as opposed to hazy or opaque articles made from the compositions in the process of the prior art (due to the degradation of the microcapsules).

In one embodiment, the composition with lubricant microcapsules may be used for dry sliding applications as an as bearing seal, or a sealing element for cylinders and pistons for a reciprocating compressor, having reduce wear and/or appreciably improved service life. In a second embodiment, the composition is used as an abradable seal member in a seal assembly for rotary machines such as a turbine. The composition may be used as piston components for automotive engines for high-temperature operations.

All cited patents, patent applications, and other references are incorporated herein by reference in their entirety. The invention is further illustrated by the following non-limiting examples.

### EXAMPLES

In the examples, the PBT polymer used in all examples is available from General Electric Company (“GE”) as Valox PBT 315 resin or PBT 195 resins. PET polymer used is available from GE as Valox PET 962 resin. Polyetherimide is available from GE as Ultem PEI 1010 resin. The polycarbonate used is also available from GE as Lexan PC105 or PC175 resins as indicated. The PEEK used is commercially available from Victrex as Victrex P151. Nylon 6 is commercially available from E.I. duPont de Nemours & Co. (“DuPont”). The polyacetal used is available for Hoescht Celanese as Hostaform POM C13031. PTFE lubricant is from DuPont.

The microcapsules used in the examples are from Aveka, Inc. of Minnesota, USA, having a PMU shell and with lubricants as the encapsulated additive. The lubricants are from ExxonMobil Corp. as Gargoyle Artic SHC 226.

### Example A

Compositions comprising 10 wt. % microcapsules in PET and PEEK as the polymer matrix material was prepared using a process of the prior art, i.e., direct melt-blending of microcapsules in the composition. Oil capsules could be visibly observed in the compounded PET pellets, with some of the oil capsules appearing to be elongated (degraded) by the compounding process. Additionally, the capsules were visible in the PEEK molded specimen.

### Example B

In this example, microcapsules in quantity from 10 to 30 wt. % were added directly to PEI composition via a side feeder of a Werner & Pfleiderer extruder (2 holes, two 2 lobs screws, and 9 barrels). PEI was added at the throat feeder. The process came to a halt when the microcapsules degrade, generating formaldehyde over an acceptable level for the operators to stay in the room.

### Example C

Up to 30 wt. % of microcapsules were first incorporated into PET as a carrier polymer, with the melt blending being carried at a temperature of about 260° C., and with the microcapsules being added to the extruder via a side feeder in a dry-blend with the PET carrier polymer. The masterbatches in various portions (e.g., 90% PET, 10% microcapsules, etc.) were blended into compositions with PEI 1010, or a blend of PEI 1010 and PET 962 as the polymer matrix in various amounts (wt. %) as shown in Table 1 below. No oil burning or smoke was detected

TABLE 1

| | Example 1 | Example 2 | Example 3 | Example 4 | Example 5 |
|---|---|---|---|---|---|
| PET/MC | 19.5 | — | — | — | 30 |
| 90/10 | | | | | |
| PET/MC | — | 20.6 | — | — | — |
| 85/15 | | | | | |
| PET/MC | — | — | 22 | — | — |
| 80/20 | | | | | |
| PEI 1010 | 80.5 | 79.4 | 78 | 82.5 | 70 |
| PET 962 | — | — | — | 17.5 | — |
| milled | | | | | |

### Example D

In this example, microcapsules in various amounts are first dry-blended with milled PEI 1010. The dry-blend was compounded into PEI 1010 as a matrix carrier in various amounts (wt. %) and with the extruder being set at a high temperature of 350° C. The dry-blend of PEI 1010 and microcapsules were fed downstream and via a side feeder, with the matrix polymer being fed directly to the main feeder of a Werner & Pfleiderer extruder. As with the examples employing a masterbatch as a carrier for microcapsules, no oil burning or smoke was detected in all 3 runs at 350° C.

TABLE 2

| | Example # 5 | Example # 6 | Example # 7 |
|---|---|---|---|
| PEI 1010 | 87 | 80 | 78 |
| Dry blend | | | |
| PEI 1010 milled | 10 | 15 | 15 |
| Microcapsules | 3 | 5 | 7 |

### Example E

Example D was repeated, except that the processing was at 370° C. The process halted due to the formaldehyde release over MAC.

### Example F

In the examples, microcapsules in various amounts are first dry-blended with PC175. The dry-blend was compounded into PC105 as a matrix carrier in various amounts (wt. %) and with the extruder being set at a temperature of 300° C., and PC175 with the extruder temperature being set at 275° C. The results are as presented in Table 3. NOK means that the formaldehyde was over an acceptable level.

TABLE 3

| | Ex. 8 | Ex. 9 | Ex. 10 | Ex. 11 | Ex. 12 | Ex. 13 |
|---|---|---|---|---|---|---|
| PC105 | | | | 89.9 | 89.9 | 89.9 |
| PC175 | 89.9 | 89.9 | 89.9 | | | |
| Antioxidant | 0.1 | 0.1 | 0.1 | 0.1 | 0.1 | 0.1 |
| Dry blend | | | | | | |
| PC175 | 7 | 5 | 9 | 9 | 5 | 7 |
| Microcapsules | 3 | 5 | 1 | 1 | 5 | 3 |
| Monitoring | OK | OK | OK | OK | NOK | NOK |

*Antioxidant used was Tris(di-t-butylphenyl) phosphite

### Example G

In the examples, microcapsules in various amounts are first dry-blended with PBT195. The dry-blend was compounded into blends of PBT195 and PBT315 as a polymer matrix in various amounts (wt. %) as presented in Table 4, and with the extruder being set at a temperature of 260° C. In the examples, the antioxidant was Tris(di-t-butylphenyl) phosphate. Pentaerythritol tetrastearate was used as a release agent. Glass fiber having an average length of 14 μm was used as the filler. No oil burning or smoke was detected in all runs.

TABLE 4

| | Ex. 14 | Ex. 15 | Ex. 16 | Ex. 17 | Ex. 18 | Ex. 19 |
|---|---|---|---|---|---|---|
| PBT195 | 24.8 | 19.8 | 19.8 | 19.8 | 19.8 | 23.3 |
| PBT315 | 34.8 | 29.8 | 29.8 | 29.8 | 29.8 | 33.3 |
| Release Agent | 0.3 | 0.3 | 0.3 | 0.3 | 0.3 | 0.3 |
| Antioxidant | 0.1 | 0.1 | 0.1 | 0.1 | 0.1 | 0.1 |
| Glass Fiber | 30 | 30 | 30 | 30 | 30 | 30 |
| PTFE | | | 10 | 5 | | |
| Dry blend | | | | | | |
| PBT195 | 10 | 10 | 10 | 10 | 10 | 10 |
| Microcapsules | | 10 | | 5 | 10 | 3 |

### Example H

In the examples, microcapsules in various amounts are first dry-blended with nylon 6 (PA6). The dry-blend was compounded into blends of PA6 as a polymer matrix in various amounts (wt. %) as presented in Table 5, and with the extruder being set at a temperature of 240° C. In the examples, the release agent used was EBS wax. The antioxidants were phosphonite PEPQ and phenolic antioxidant for PA6. No oil burning or smoke was detected in all runs.

TABLE 5

| | Ex. 20 | Ex. 21 | Ex. 22 | Ex. 23 | Ex. 24 |
|---|---|---|---|---|---|
| PA6 | 84.5 | 80.5 | 74.5 | 99.5 | 84.5 |
| Release Agent | 0.3 | 0.3 | 0.3 | 0.3 | 0.3 |
| Antioxidant 1 | 0.1 | 0.1 | 0.1 | 0.1 | 0.1 |
| Antioxidant 2 | 0.1 | 0.1 | 0.1 | 0.1 | 0.1 |
| Dry blend | | | | | |
| PA6 milled | 10 | 12 | 15 | | 10 |
| Microcapsules | 5 | 7 | 10 | 0 | 5 |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

All citations referred herein are expressly incorporated herein by reference.

1. A method for preparing a polymeric composition, comprising the steps of:
mixing a plurality of encapsulated materials containing at least an additive with a carrier polymeric material to form a first blend;
compounding the first blend into a polymer matrix comprising a polymer material same or different from the carrier polymeric material;
wherein the compounding is at a process temperature of less than 370° C.; and wherein
the resulting composition is substantially free of segregated microcapsules and heat degraded shell.

2. The process of claim 1, wherein the encapsulated materials are microcapsules or nanocapsules.

3. The process of claim 1, wherein the average diameter of the said encapsulated material is greater than 5 nm.

4. The process of claim 1, wherein the additive contained in the encapsulated materials is a phase change material selected from the group of lubricants, oils, fragrances, flavorants, catalysts, and mixtures thereof.

5. The process of claim 1, wherein the microcapsules contain at least one of lubricants, oils, and mixtures thereof.

6. The process of claim 1, wherein the compounding is carried out at a compounding temperature of less than 300° C.

7. The process of claim 4, wherein the compounding is carried out at a compounding temperature of less than 285° C.

8. The process of claim 5, wherein the compounding is carried out at a compounding temperature of less than 260° C.

9. The process of claim 1, wherein the microcapsules comprise a shell of polyoxymethylene urea (PMU).

10. The process of claim 6, characterized in that formaldehyde released from the heat degraded shell comprising polyoxymethylene urea is less than a MAC level.

11. The process of claim 6, characterized in that formaldehyde released from the heat degraded shell comprising polyoxymethylene urea is less than 1 ppm.

12. The process of claim 1, wherein the plurality of microcapsules containing a lubricating material is mixed with the carrier polymeric material by melt-blending and wherein the carrier polymeric material has a melting point of <285° C.

13. The process of claim 9, wherein the carrier polymeric material has a melting point of <260° C.

14. The process of claim 1, wherein the carrier polymeric material is selected from the group consisting of polyethylene terephthalate, polybutylene terephthalate, polycarbonate homopolymers, polyestercarbonate copolymers, linear aromatic polycarbonate resins, branched aromatic polycarbonate resins, poly(ester-carbonate) resins; polyamides, polyacetal, polyethylene, polypropylene, copolymers of olefins, halogenated vinyl polymers, vinylidene polymers, polyvinylidene chloride, polyvinyl fluoride, polyvinylidene fluoride, polyamide copolymers, styrene polymers, styrene copolymers, polyacrylonitrile, silicone resins, polyethers, polyketones, polyimides, modified celluloses, polysulphones and mixtures thereof.

15. The process of claim 11, wherein the carrier polymer is selected from the group consisting of polycarbonate, polyethylene terephthalate, polybutylene terephthalate, polyamide, polyimide, and mixtures thereof.

16. The process of claim 1, wherein the polymer matrix comprises a high-temperature material selected from the group of polyarylene sulfides, polyphenylene sulfide (PPS), polyetheretherketone (PEEK), polyetherketone (PEK), polyphthalamide (PPA), polyetherketoneketone (PEKK), thermoplastic polyimide (TPI), high temperature nylon (HTN), polysulfone (PSU), polyethersulfone (PES), polyetherimide (PEI), and blends thereof.

17. The process of claim 1, wherein the plurality of microcapsules containing a lubricating material is mixed with the carrier polymeric material by dry-blending.

18. The process of claim 1, wherein the plurality of microcapsules containing a lubricating material is mixed with the carrier polymeric material by dry-blending or melt-blending to form a first blend, and wherein the first blend is compounded into a polymer matrix comprising a polymer material same or different from the carrier polymeric material, and wherein
the first blend is compounded into the polymer matrix through a downstream feeding point from the polymer matrix material.

19. The process of claim 15, wherein the downstream feeding point for the first blend is at a temperature of less than 285° C.

20. The process of claim 16, wherein the downstream feeding point is a side feeder of an extruder.

21. The process of claim 1, wherein said microcapsules have an average diameter of between 5 and 500 μm.

22. The process of claim 18, wherein said microcapsules have an average diameter of between 20 and 200 μm.

23. The process of claim 1, wherein the microcapsules are present in an amount of about 1 wt % to about 40 wt % of the total weight of the composition.

24. The process of claim 20, wherein the microcapsules are present in an amount of about 5 wt % to about 40 wt % of the total weight of the composition.

25. The process of claim 1, wherein the carrier polymeric material is present in an amount of about 5 wt % to about 40 wt % of the total weight of the composition.

26. The process of claim 17, wherein the carrier polymeric material present in an amount of about 5 wt % to about 30 wt % of the total weight of the composition.

27. The process of claim 18, wherein the carrier polymeric material is present in an amount of about 5 wt % to about 20 wt % of the total weight of the composition.

28. The process of claim 1, wherein the material comprising the polymer matrix is present in an amount of about 40 wt % to about 90 wt % of the total weight of the composition

29. The process of claim 25, wherein the material comprising the polymer matrix is present in an amount of about 50 wt % to about 80 wt % of the total weight of the composition

30. The process of claim 26, wherein the material comprising the polymer matrix is present in an amount of about 60 wt % to about 80 wt % of the total weight of the composition

31. A composition made by the process of claim 1.

32. A composition comprising a plurality of microcapsules containing at least an additive, wherein
the plurality of microcapsules are first mixed into a carrier polymeric material forming a concentrate blend, and
the concentrate blend is subsequently compounded into a polymer matrix comprising a polymer material same or different from the carrier polymeric material, and wherein
the composition is substantially free of segregated microcapsules and heat degraded shell.

33. The composition of claim 29, wherein less than 10% of the microcapsules are segregated or having heat degraded shell.

34. The composition of claim 30, wherein less than 5% of the microcapsules are segregated or having heat degraded shell.

35. The composition of claim 31, wherein less than 3% of the microcapsules are segregated or having heat degraded shell.

36. The composition of claim 29, wherein the microcapsules contain at least a lubricant.

37. The composition of claim 29, wherein the carrier polymer comprises at least one of polycarbonate, polyethylene terephthalate, polybutylene terephthalate, polyamide, polyimide, and mixtures thereof.

38. The composition of claim 29, wherein the polymer matrix comprises a high-temperature material selected from the group of polyarylene sulfides, polyphenylene sulfide (PPS), polyetheretherketone (PEEK), polyetherketone (PEK), polyphthalamide (PPA), polyetherketoneketone (PEKK), thermoplastic polyimide (TPI), high temperature nylon (HTN), polysulfone (PSU), polyethersulfone (PES), polyetherimide (PEI), and blends thereof.

39. The composition of claim 29, wherein the microcapsules are present in an amount of about 1.0 wt % to about 40 wt % of the total weight of the composition

40. A composition comprising a plurality of microcapsules containing at least an additive, wherein
the plurality of microcapsules are first mixed into a carrier polymeric material forming a concentrate blend, and
the concentrate blend is subsequently compounded into a polymer matrix comprising a polymer material same or different from the carrier polymeric material, and wherein
the compounding is at a process temperature of less than 370° C.

41. The composition of claim 33, the compounding is at a process temperature of less than 300° C.
